(19) United States
(12) Patent Application Publication
(10) Pub. No.: US 2025/0310435 A1
(43) Pub. Date: Oct. 2, 2025

(54) GROUP-BASED DO-NOT-DISTURB MODE FOR A COMMUNICATION DEVICE

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN)

(21) Appl. No.: 18/619,662

(22) Filed: Mar. 28, 2024

(51) Int. Cl. H04M 1/72463; H04M 1/72436; H04M 1/72454

(52) U.S. Cl. CPC H04M 1/72463; H04M 1/72454; H04M 1/72436

(57) ABSTRACT

A method provides techniques for determining an adverse health status of a first individual within an established association of two or more individuals. The method includes determining, in part based on the adverse health status of the first individual, a setting for a group-based do-not-disturb (GBDnD) mode to activate on the communication device. The method further includes activating the GBDnD mode, and transmitting to one or more second communication devices of each other individual within the established association, an indication of the activation of the GBDnD mode on the communication device and notification of the adverse health status. The method can further include generating a delivery postponement notice for the scheduled delivery and communicating the delivery postponement notice to a delivery service account device, while operating in a GBDnD mode.

### BACKGROUND

### 1. Technical Field

The present disclosure generally relates to portable electronic devices, and more specifically to portable electronic devices that enable group-based communication.

### 2. Description of the Related Art

Group-based communication on smartphones can enable users to create or participate in group conversations. Users can create a group within a messaging app or social media platform. The users usually have the option to name the group and add members to it. Depending on the platform, there may be limitations on the number of members allowed in a group. Once the group is created, members can exchange messages within the group. These messages can include text, images, videos, interactive voice sessions, voice notes, or other multimedia content supported by the platform. Furthermore, users may receive notifications when there are new messages in the group. Additionally, group members may be able to share media files such as photos, videos, documents, and links with each other.

Group-based communication provides numerous benefits and advantages. For social purposes, group-based communication allows friends and family to create group chats to stay connected, share updates, make plans, and coordinate events. Work or study groups can use group messaging to collaborate on projects, share resources, discuss ideas, and coordinate tasks. Moreover, groups can be created for organizing events such as parties, outings, or trips. Members can discuss details, make decisions, and keep everyone informed about the plans. Additionally, groups can be formed around specific interests or hobbies, such as sports teams, fan clubs, book clubs, or gaming communities. Members can discuss their interests, share content, and arrange meetups. Overall, group-based communication on communication devices facilitates real-time interaction and collaboration among multiple users, enabling them to connect, communicate, and share information conveniently.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components that enable the device to implement a group-based do-not-disturb (GBDnD) mode, according to one or more embodiments;

FIG. 2 depicts an exemplary interconnected group of communication devices, with group-based do-not-disturb mode active, according to one or more embodiments;

FIG. 3 illustrates an exemplary user interface for setting a group-based do-not-disturb mode for an individual member of a group, according to one or more embodiments;

FIG. 4 illustrates an exemplary user interface indicating an adverse health status of another member of the group, according to one or more embodiments;

FIG. 5 illustrates an exemplary user interface for communicating with an individual while the group-based do-not-disturb mode is active for that individual, according to one or more embodiments;

FIG. 6 illustrates an exemplary user interface for entering caregiver coverage periods, according to one or more embodiments;

FIG. 7 illustrates an exemplary user interface depicting a combined caregiver schedule for an individual within the group, according to one or more embodiments;

FIG. 8 illustrates an exemplary user interface depicting notification of a rescheduled delivery, according to one or more embodiments;

FIG. 9 depicts a flowchart of a method for activating group-based do-not-disturb (GBDnD) mode, according to one or more embodiments;

FIG. 10 depicts a flowchart of a method for delivery management when GBDnD mode is in effect, according to one or more embodiments; and

FIG. 11 depicts a flowchart of a method for setting a health status and activating a GBDnD mode based on biometric data, according to one or more embodiments.

### DETAILED DESCRIPTION

According to aspects of the present disclosure, an electronic device, a method, and a computer program product provide techniques for implementing a group-based do-not-disturb (GBDnD) mode on the electronic device. A health monitoring and communication coordination (HMCC) group of two or more individuals is established, each individual having a respective communication device with a communication identifier (ID) and identified as included within the established association. An adverse health status of a first individual within the group is detected or reported. Based on the adverse health status, a setting for a GBDnD mode is determined and the GBDnD mode is activated. In response to activating the GBDnD mode, an indication of the activation of the GBDnD mode is communicated to one or more second communication devices of each other individual within the established association. In response to activation of the GBDnD mode, one or more notifications are silenced on the communication device associated with the first individual.

Group-based communication has a wide variety of applications and uses. However, when a person within the group has an adverse health status, such as being sick, injured, or generally not feeling well, the communication can have an adverse effect. In particular, when a family member falls ill, other family members may increase their rate of calling or texting the ill family member out of concern. The incoming calls and notifications can disrupt sleep and/or recovery. The interruptions from incoming calls and texts can exacerbate symptoms such as headaches, nausea, or dizziness. Moreover, even if the texts/calls are unanswered, they can interrupt rest, which is crucial for recovery when someone is sick. Texts or calls can disrupt the person's rest, hindering their ability to recuperate and potentially prolonging the duration of illness. Additionally, a steady barrage of notifications or calls may cause stress or anxiety for the sick person, especially if the person feels pressured to respond, or if the messages contain urgent or concerning information. Furthermore, engaging in conversations via text or phone calls may distract the sick person from focusing on their recovery, leading to slower healing or prolonging the duration of illness.

The disclosed embodiments alleviate the aforementioned issues caused by excessive communication directed towards an individual with an adverse health status. According to the disclosure, an adverse health status of an individual within an established group is detected. In one or more embodiments, the detection of the adverse health status can be self-reported, reported by another member of the group, and/or detected via biometric information from connected sensors or devices such as thermometers, blood pressure measuring devices, blood sugar measuring devices, and the like. Once the adverse health status of the individual is obtained, a group-based do-not-disturb (GBDnD) mode is activated. Calls and texts may be silenced on/at the user's device while the device is in the GBDnD mode. In one or more embodiments, a duration may be established for the GBDnD mode, such as 8 hours, 24 hours, or other suitable duration. Additionally, scheduled deliveries destined for the mailing address associated with the individual with the adverse health status may be rescheduled or re-directed to an alternate delivery location while the GBDnD mode is in effect. One or more embodiments also can provide a feature of notifying other members of the group about the adverse health status of the individual Additionally, one or more embodiments enable a caregiver scheduling feature, in which one or more members of the group can post their availability to care for the individual with the adverse health status. Accordingly, disclosed embodiments can help accelerate the recovery of an individual with an adverse health status by shielding the individual from excessive disturbances, enabling the individual to rest and recover, and potentially providing a caregiver to aid the individual in/during the individual's recovery.

According to one or more embodiments, a health monitoring and communication coordination (HMCC) group is established and/or defined within a user device application. The group includes at least two members. In a usage scenario, the group may represent a family, extended family, neighbors, and/or other associated people. An adverse health status for one or more group members is determined. The adverse health status can be self-reported, or reported by other members of the group.

Additionally, in one or more embodiments, an adverse health status may be automatically derived/obtained from biometric data from one or more biometric data collection devices. The biometric data collection devices can include ‘smart’ devices that include a processor along with a communication interface such as a WiFi and/or Bluetooth interface. Thus, biometric data collection devices such as thermometers, blood sugar measuring devices, and blood pressure measuring devices can automatically provide acquired biometric data to a device such as a smartphone. As an example, if a user takes his/her temperature with a smart thermometer, and an elevated temperature is registered, then in response to receiving the elevated temperature data, an adverse health status may be automatically set e.g., within the user device or HMCC app, for the individual.

According to one or more embodiments, once it is determined that a member of the group is in an adverse health status, one or more actions are taken to reduce disturbances to the individual as part of the GBDnD mode. These actions can include silencing incoming calls, messages, and/or notifications. Moreover, the actions can include notifying other members of the group about the adverse health status for the individual. The silencing of calls, messages, and/or notifications can help reduce disturbances for the individual with the adverse health status, allowing the person time to rest and recover. Additionally, one or more embodiments may automatically identify incoming deliveries, such as from ecommerce sites and/or other merchants. In one or more embodiments, incoming shipments are rescheduled and/or rerouted to an alternate delivery location as a result of the GBDnD mode being set for the individual. The feature of rescheduling and/or rerouting deliveries can further minimize disturbances for the individual with an adverse health status, enabling him/her to get more rest, enabling a faster recovery.

According to one or more embodiments, a scheduling feature enables caregivers to create and/or view a schedule of caregiving for the individual with the adverse health status. The scheduling feature provides individuals from the group the ability to submit their availability for caring for the individual with the adverse health status. The caregiver schedule can automate finding of caregivers from within the group and simplify the task of caring for a member of the group that has an adverse health status. These, and other advantages of disclosed embodiments are further explained in the following detailed description.

One or more embodiments can include an electronic device including: at least one output device, including a display; a communication system; a memory having stored thereon a group-based do-not-disturb (GBDnD) module; and at least one processor communicatively coupled to the display, the communication system, and the memory, the at least one processor executing program code of the GBDnD module and configuring the communication device to: determine an adverse health status of a first individual within an established association of two or more individuals, each having a communication identifier (ID) and identified as included within the established association; determine, in part based on the adverse health status of the first individual, a setting for a group-based do-not-disturb (GBDnD) mode to activate on the communication device; activating the GBDnD mode based on the setting; and in response to activating the GBDnD mode: transmit, via the communication system, to one or more second communication devices of each other individual within the established association, an indication of the activation of the GBDnD mode on the communication device and notification of the adverse health status; and silence one or more notifications of the communication device.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

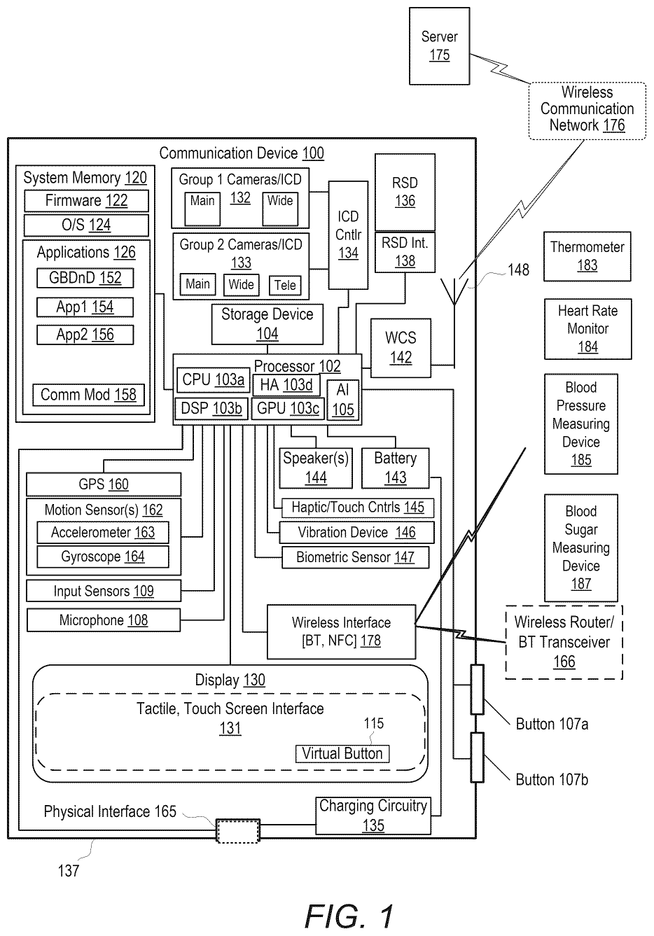

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Electronic device 100 includes specific components that enable the device to provide group-based do-not-disturb functions, according to one or more embodiments. Examples of electronic device 100 include, but are not limited to, mobile devices, a notebook computer, a mobile phone, a smart phone, a digital camera with enhanced processing capabilities, a smart watch, a tablet computer, and other types of electronic device.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can interchangeably be referred to as controller 102.

Processor 102 can, in some embodiments, include image signal processors (ISPs) (not shown) and dedicated artificial intelligence (AI) engines 105. In one or more embodiments, processor 102 can execute AI modules to provide AI functionality of AI engines 105. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Processor 102 is communicatively coupled to storage device 104, system memory 120, input devices (introduced below), output devices, including integrated display 130, and image capture device (ICD) controller 134.

ICD controller 134 can perform image acquisition functions in response to commands received from processor 102 in order to control group 1 ICDs 132 and group 2 ICDs 133 to capture video or still images of a local scene within a FOV of the operating/active ICD. In one or more embodiments, group 1 ICDs can be front-facing, and group 2 ICDs can be rear-facing, or vice versa. Throughout the disclosure, the term image capturing device (ICD) is utilized interchangeably to be synonymous with and/or refer to any one of the cameras 132, 133. Both sets of cameras 132, 133 include image sensors that can capture images that are within the field of view (FOV) of the respective camera 132, 133.

In one or more embodiments, the functionality of ICD controller 134 is incorporated within processor 102, eliminating the need for a separate ICD controller. Thus, for simplicity in describing the features presented herein, the various camera selection, activation, and configuration functions performed by the ICD controller 134 are described as being provided generally by processor 102. Similarly, manipulation of captured images and videos are typically performed by GPU 103c and certain aspects of device communication via wireless networks are performed by DSP 103b, with support from CPU 103a. However, for simplicity in describing the features of the electronic device 100, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical images within a display.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, GBDnD module 152, other applications, indicated as App1 154, App2 156, and communication module 158. Each module and/or application provides program instructions/code that are processed by processor 102 to cause processor 102 and/or other components of electronic device 100 to perform specific operations, as described herein. Descriptive names assigned to these modules add no functionality and are provided solely to identify the underlying features performed by processing the different modules. For example, GBDnD module 152 can include program instructions for implementing features of disclosed embodiments.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program code and corresponding data, and RSD 136 can be interchangeably referred to as a non-transitory computer program product. RSD 136 may have a version of one or more applications stored thereon. Processor 102 can access RSD 136 to provision electronic device 100 with program code that, when executed/processed by processor 102, the program code causes or configures processor 102 and/or generally electronic device 100, to provide the various group-based do-not-disturb functions described herein.

Electronic device 100 includes an integrated display 130 which incorporates a tactile, touch screen interface 131 that can receive user tactile/touch input. As a touch screen device, integrated display 130 allows a user to provide input to or to control electronic device 100 by touching features within the user interface presented on display 130. Tactile, touch screen interface 131 can be utilized as an input device. The touch screen interface 131 can include one or more virtual buttons, indicated generally as 115. In one or more embodiments, when a user applies a finger on the touch screen interface 131 in the region demarked by the virtual button 115, the touch of the region causes the processor 102 to execute code to implement a function associated with the virtual button. In some implementations, integrated display 130 is integrated into a front surface of electronic device 100 along with front ICDs, while the higher quality ICDs are located on a rear surface.

Electronic device 100 can further include microphone 108, one or more output devices such as speakers 144, and one or more input buttons, indicated as 107a and 107b. While two buttons are shown in FIG. 1, other embodiments may have more or fewer input buttons. Microphone 108 can also be referred to as an audio input device. In some embodiments, microphone 108 may be used for identifying a user via voiceprint, voice recognition, and/or other suitable techniques. Input buttons 107a and 107b may provide controls for volume, power, and ICDs 132, 133. Additionally, electronic device 100 can include input sensors 109 (e.g., sensors enabling gesture detection by a user).

Electronic device 100 further includes haptic touch controls 145, vibration device 146, fingerprint/biometric sensor 147, global positioning system (GPS) module 160, and motion sensor(s) 162. Vibration device 146 can cause electronic device 100 to vibrate or shake when activated. Vibration device 146 can be activated during an incoming call or message in order to provide an alert or notification to a user of electronic device 100. According to one aspect of the disclosure, integrated display 130, speakers 144, and vibration device 146 can generally and collectively be referred to as output devices.

Biometric sensor 147 can be used to read/receive biometric data, such as fingerprints, to identify or authenticate a user. In some embodiments, the biometric sensor 147 can supplement an ICD (camera) for user detection/identification. In one or more embodiments, the electronic device 100 can be a wearable device, and the biometric sensor 147 can include a body temperature sensor, heart rate sensor, oximetry sensor, and/or other type of sensor that can collect heath data.

GPS module 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can be used as a power supply port that is coupled to charging circuitry 135 and device battery 143 to enable recharging of device battery 143 and/or powering of device.

Electronic device 100 further includes wireless communication subsystem (WCS) 142, which can represent one or more front end devices (not shown) that are each coupled to one or more antennas 148. In one or more embodiments, WCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 176 and with other devices, such as server 175 and other connected devices, via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WCS 142 and antennas 148 allow electronic device 100 to communicate wirelessly with wireless communication network 176 via transmissions of communication signals to and from network communication devices, such as base stations or cellular nodes, of wireless communication network 176. Wireless communication network 176 further allows electronic device 100 to wirelessly communicate with server 175, and other communication devices, which can be similarly connected to wireless communication network 176. In one or more embodiments, various functions that are being performed on communications device 100 can be supported using or completed via/on server 175.

Electronic device 100 can also wirelessly communicate, via wireless interface(s) 178, with wireless communication network 176 via communication signals transmitted by short range communication device(s). Wireless interface(s) 178 can be a short-range wireless communication component providing Bluetooth, near field communication (NFC), and/or wireless fidelity (Wi-Fi) connections. In one or more embodiments, electronic device 100 can receive Internet or Wi-Fi based calls, text messages, multimedia messages, and other notifications via wireless interface(s) 178. In one or more embodiments, electronic device 100 can communicate wirelessly with external wireless device 166, such as a WiFi router or BT transceiver, via wireless interface(s) 178. In one or more embodiments, WCS 142 with antenna(s) 148 and wireless interface(s) 178 collectively provide wireless communication interface(s) of electronic device 100.

In one or more embodiments, the wireless interface(s) 178 can enable electronic device 100 to communicate with one or more smart biometric data collection devices, including, but not limited to, thermometer 183, heart rate monitor 184, blood pressure measuring device 185, and/or blood sugar measuring device 187. The data from the smart biometric data collection devices can be used to automatically detect an adverse health status. One or more embodiments can include: obtaining biometric data from one or more biometric data collection devices; determining if the biometric data has a value outside of a predetermined range that is indicative of an adverse health status; and in response to determining that the biometric data has a value outside of the predetermined range, setting the health status of the individual to the adverse health status. The value can include a temperature value, blood pressure value, blood sugar level, pulse rate, and/or other suitable biometric data value.

Electronic device 100 of FIG. 1 is only a specific example of a device that can be used to implement the embodiments of the present disclosure. Devices that utilize aspects of the disclosed embodiments can include, but are not limited to, a smartphone, a tablet computer, a laptop computer, a desktop computer, a wearable computer, and/or other suitable electronic device.

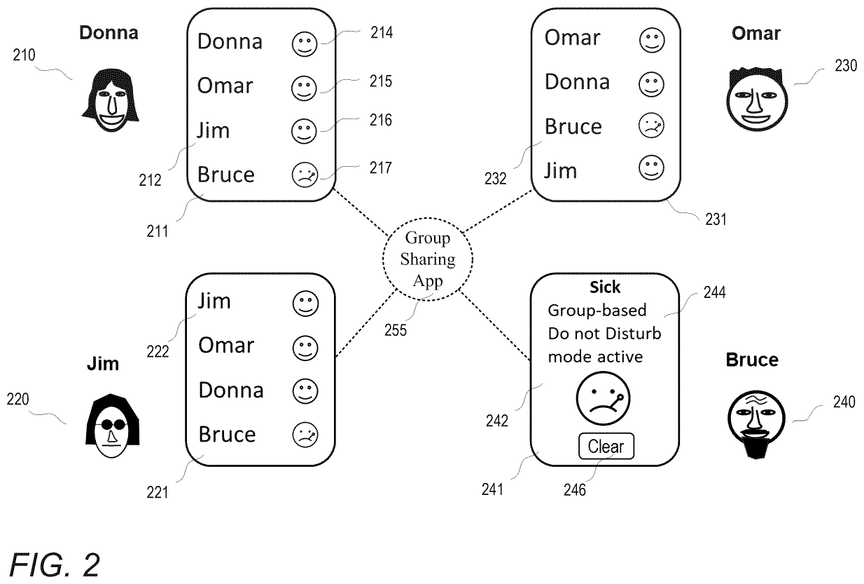

FIG. 2 depicts an exemplary group of communicatively-connected communication devices, with group-based do-not-disturb mode active, according to one or more embodiments. As depicted in FIG. 2, four members of an established group, along with their corresponding communication device are shown interconnected for health-related communication exchange via a group sharing application or function 255. In one embodiment, the group sharing application/function 255 is a virtual information exchange mechanism that utilizes a combination of a local device application and exiting wireless network connections between the devices to transact information exchange about the health status of the different members of the established group. User Donna 210 has corresponding communication device 211 with electronic display 212. User Jim 220 has corresponding communication device 221 with electronic display 222. User Omar 230 has corresponding communication device 231 with electronic display 232. User Bruce 240 has corresponding communication device 241 with electronic display 242. Each communication device shows a group status. Referring to communication device 211, a health status indication is shown for each member of the group. Health status indication 214 corresponds to Donna, health status indication 215 corresponds to Omar, health status indication 216 corresponds to Jim, and health status indication 217 corresponds to Bruce. The health status indications 214, 215, and 216 are positive health status indications, indicating that the person corresponding to the respective health status indication does not have an adverse health status reported. However, health status indication 217 corresponding to Bruce 240 is an adverse health status indication, indicating that Bruce is reported as being ailing (i.e., injured, sick, recovering, etc.).

In one or more embodiments, health status indication 217 can serve as a GBDnD tag. The GBDnD tag can serve to indicate to other members of the group about the adverse health status of an individual. The GBDnD tag can appear in a contact list or other user interface(s) that displays information about group members. One or more embodiments can include, in response to determining the adverse health status of the individual, for each contact of a group of contacts, providing an adverse status indication for the individual to a corresponding communication device associated with the contact entry for the individual that is stored in the content list. One or more embodiments can include, in response to receiving an incoming adverse health status associated with another individual within the associated individuals: marking a contact of the other individual with a GBDnD tag; and surfacing the GBDnD tag to alert the first individual of the GBDnD in response to detecting selection of the contact entry for communicating with the first individual.

Electronic device 221 corresponding to user Jim 220 and electronic device 231 corresponding to user Omar 230 display a similar listing of the group members and their corresponding health status indications. For user Bruce 240, who is ailing, his health status is set to an adverse health status, which activates the group-based do-not-disturb (GBDnD) mode for communication device 241. In one or more embodiments, when the GBDnD mode is activated for a device, a user interface renders a message 244 indicating that the GBDnD mode is in effect. Additionally, a button 246 may be presented on the user interface, enabling the user to clear the adverse health status and remove the GBDnD mode from the communication device 241 in response to a user invoking button 246. If the adverse status has been communicated to the other users, the user's invocation of button 246 initiates transmission of an “all-clear” signal to also clear the adverse health status of the user on each of the communicatively connected user devices of the other users.

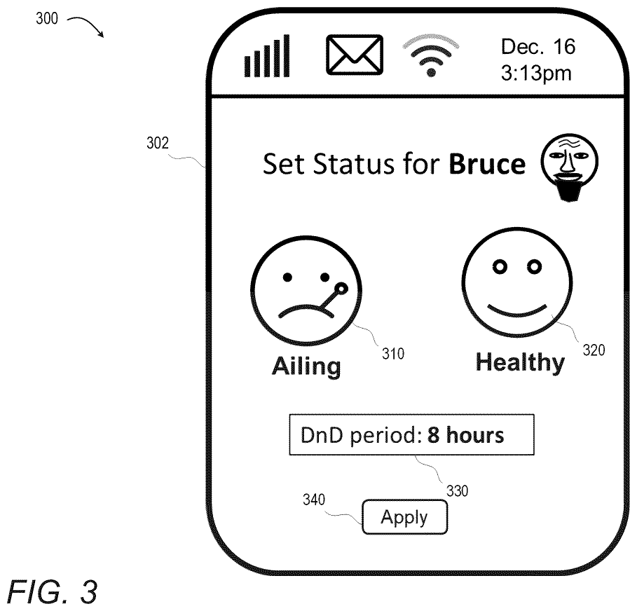

FIG. 3 illustrates an exemplary user interface 300 for setting a group-based do-not-disturb mode for an individual member of a group, according to one or more embodiments. In one or more embodiments, the user interface shown in FIG. 3 may be rendered on a display 302 of a device such as device 100 of FIG. 1. The user interface 300 includes a first button 310 to set the health status of an individual as adverse (ailing), which is indicative of the user being ailing, such as being injured, sick, extremely tired, etc. The user interface 300 includes a second button 320 to set the health status of an individual as well, which is indicative of the user being healthy (i.e., not ailing). While two separate buttons are shown in FIG. 3, in one or more embodiments, a single button may be used to toggle between an ailing status and a healthy status. A time/duration field 330 enables specifying of a do-not-disturb (DnD) period. In one or more embodiments, the DnD period may be specified in hours, days, or other suitable time units. In one or more embodiments, after expiry of the DnD period, the device automatically deactivates or exits from the GBDnD mode. In one or more embodiments, after expiry of the DnD period, the communication device associated with the adverse health status renders a user interface to prompt the user to indicate whether he/she wishes to extend the GBDnD mode or terminate/exit the GBDnD mode (e.g., based on how the user is feeling). The user interface 300 may further include Apply button 340. Once the health status is configured as desired, the Apply button 340 can be invoked by a user. In one or more embodiments, the Apply button 340 may be invoked from the communication device associated with the individual that has the adverse health status. In one or more embodiments, the health status of an individual may also be set by another member of the group using the other member's own communication device. One or more embodiments can include obtaining a health status indication of the first individual from a corresponding communication device associated with another individual within the established association; and in response to obtaining a health status indication indicative of an adverse health status, setting the health status of the first individual to the adverse health status. The established association can include a group of family members, friends, neighbors, and the like.

In one or more embodiments, in response to the invoking of the Apply button 340, a message is sent from the communication device to the other communication devices associated with group members, to disseminate the change in health status. The communication can be accomplished via automated text messages, and/or other application messages. In one or more embodiments, the message indicating the change in health status for an individual member of the group may be sent to a server (e.g., 175 of FIG. 1), and the server 175 may then disseminate the updated health status information to the other members of the group. Additionally, the server may perform and/or orchestrate tasks such as rescheduling deliveries. In one or more embodiments, the server 175 may process text within communication from group members, such as email messages and text messages, to detect an adverse health status. In one or more embodiments, the processing of the text may include scanning for keywords, and/or natural language processing (NLP) techniques. In one or more embodiments, users may be required to opt-in to enable the server to process text from user communication messages. In one or more embodiments, the processing of text can include natural-language processing (NLP) techniques. In one or more embodiments, some or all of the NLP may be performed by artificial intelligence (AI) engines 105 (FIG. 1).

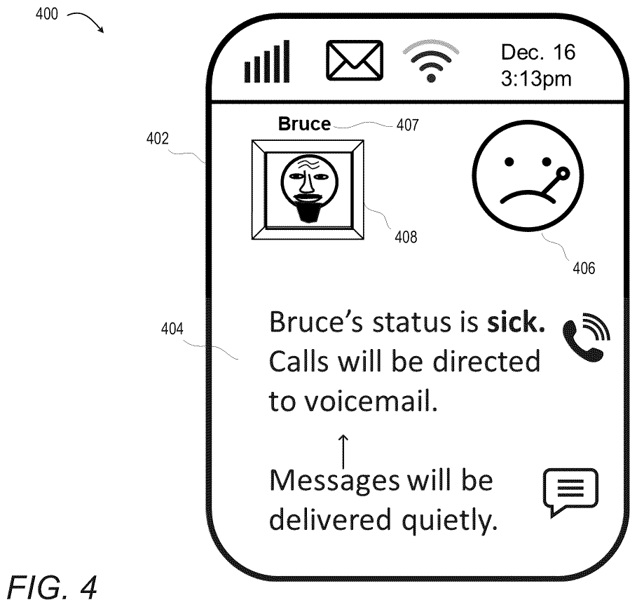

FIG. 4 illustrates an exemplary user interface 400 for setting a group-based do-not-disturb mode for an individual member of a group, according to one or more embodiments. In one or more embodiments, the user interface shown in FIG. 4 may be rendered on a display 402 of a device such as device 100 of FIG. 1. User interface 400 may be rendered on the communication device of other members of the group, to inform the other members about the current health status of a particular group member. In the example shown in FIG. 4, the user interface shows a name 407 and image 408 of the individual, along with a textual message 404 and visual indication 406 that indicate the adverse health status. In one or more embodiments, the user interface 400 may be rendered on the communication device associated with another member of the group when that other member of the group attempts to call and/or send a message to the individual with the adverse health status (‘Bruce’ in this example). In one or more embodiments, user interface 400 can be part of a texting and/or calling user interface.

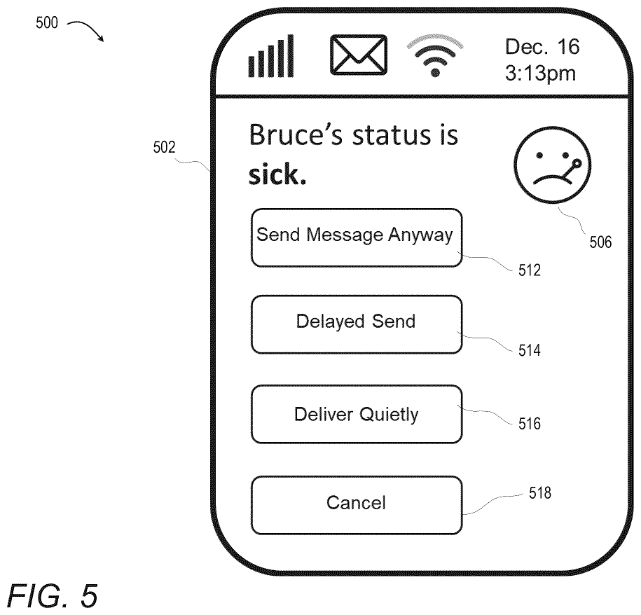

FIG. 5 illustrates an exemplary user interface 500 for communicating with an individual while the GBDnD mode is active for that individual, according to one or more embodiments. In one or more embodiments, the user interface shown in FIG. 5 may be rendered on a display 502 of a device such as device 100 of FIG. 1. In one or more embodiments, the user interface 500 is presented to another member of the group when that other member attempts to send a message to the member with the adverse health status. The user interface 500 can include a graphical indication 506 of the adverse health status. The user interface 500 can further include a send button 512, that when invoked, sends (or enables sending of) a message to the individual with the adverse health status, even with the GBDnD mode in effect. The feature provided by button 512 can be useful for urgent messages that need to be delivered even though the GBDnD mode is in effect.

The user interface 500 can further include a delayed send button 514, that when invoked, sends (or enables sending of) a message to the individual with the adverse health status, with a delayed send. In one or more embodiments, the amount of delay can be specified by the sender. In one or more embodiments, a default time delay is used. In one or more embodiments, the default time delay is determined based on the expiry of the GBDnD mode (e.g., as specified in 330 of FIG. 3). The feature provided by delayed send button 514 can be useful for messages that need to be delivered, but are not urgent enough to disturb the individual with the adverse health status.

The user interface 500 can further include a quiet delivery button 516, that when invoked, sends (or enables sending of) a message to the individual with the adverse health status, with a quiet delivery status. In one or more embodiments, metadata associated with the message indicates that the message is to be delivered quietly, meaning without audible notification of arrival of the message. In some embodiments, haptic notification is also suppressed, to prevent a vibration-based alert regarding arrival of the message. The feature provided by deliver quietly button 516 can be useful for messages that need to be delivered as soon as possible, but with the arrival notification silenced, such that if the recipient is sleeping or resting, the recipient (e.g., ‘Bruce’ in this example) is not disturbed. However, if Bruce happens to be awake and looking (or looks) at his communication device, he may receive the message sooner than if the delayed send option was used. The user interface 500 can further include a cancel button 518, that when invoked, cancels the sending and/or composing of a message. The feature of cancel button 518 can be used when the sender decides to not send a message at all at the current time, and instead may opt to check later as to if the adverse health status has changed to a well health status.

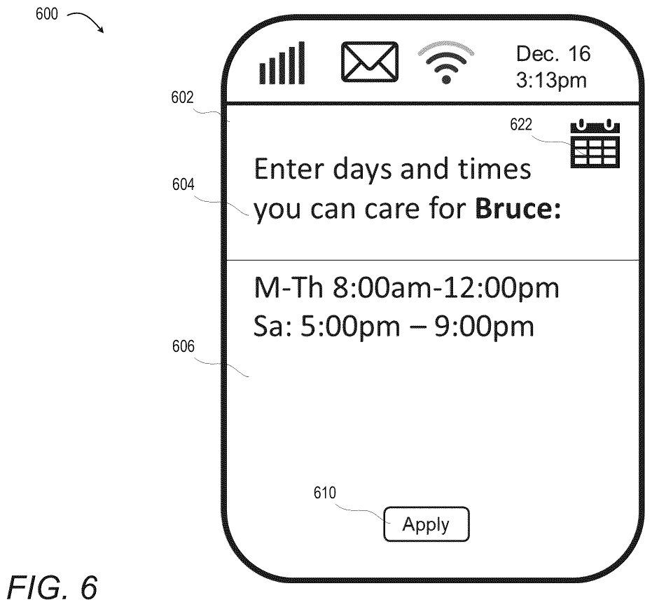

FIG. 6 illustrates an exemplary user interface 600 for entering caregiver coverage periods, according to one or more embodiments. In one or more embodiments, the user interface shown in FIG. 6 may be rendered on a display 602 of a device such as device 100 of FIG. 1. An important feature of one or more embodiments is that of creating and publishing a caregiver schedule. In one or more embodiments, a calendar icon 622 is presented within user interface 600. When calendar icon 622 is selected, one or more data entry fields may be presented to enable a user to enter dates and times for caregiver coverage periods. In situations where an individual with an adverse health status derives benefit from assistance of one or more other members of the group, the caregiver schedule can be useful to let group members indicate when they plan to be at the location of the individual with the adverse health status. The user interface 600 can include a text field 604 to prompt a group member to enter the dates/times that they can be an onsite caregiver in data entry field 606. In one or more embodiments, an option to indicate caregiver task assignments, such as meal delivery, grocery delivery, and the like, may also be provided in user interface 600.

The user interface 600 may further include Apply button 610. Once the caregiver schedule is configured as desired, the Apply button 610 can be invoked by a user (e.g., a caregiver from the group). In one or more embodiments, in response to the invoking of the Apply button 610, a message is sent from the communication device to the other communication devices associated with group members, to disseminate the caregiver schedule for the caretaker. In one or more embodiments, the message indicating the caregiver schedule for an individual member of the group may be sent to a server (e.g., 175 of FIG. 1), and the server 175 may then disseminate the caregiver schedule information for that individual to the other members of the group. In one or more embodiments, the server 175 may aggregate the caregiver schedule from multiple caregivers within the group, to create and disseminate a combined caregiver schedule that includes multiple caregivers.

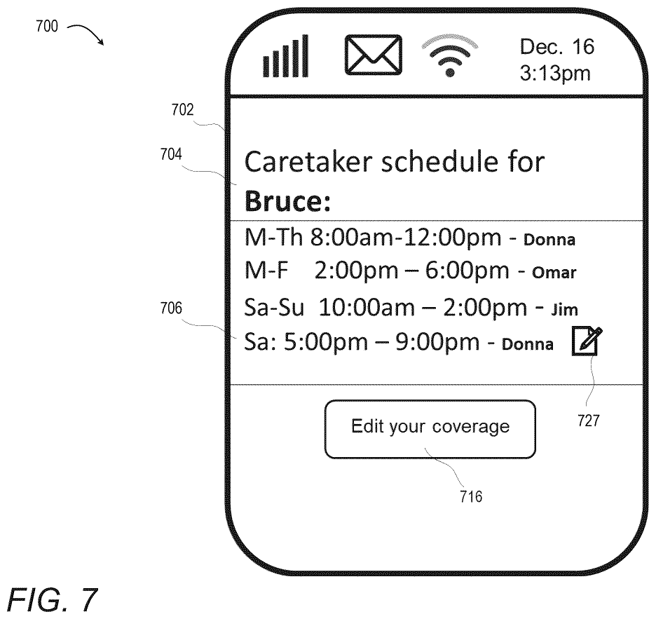

FIG. 7 illustrates an exemplary user interface 700 depicting an aggregated caregiver schedule, according to one or more embodiments. In one or more embodiments, the user interface shown in FIG. 7 may be rendered on a display 702 of a device such as device 100 of FIG. 1. User interface 700 can include a text field 704 to identify an individual from within the group that is the recipient of care provided by other group members. The user interface 700 can further include a data field 706 that renders a combined caregiver schedule that indicates the caregiver coverage periods for one or more members of the group. The user interface 700 may further include a button 716 to enable a user to edit his/her coverage periods. According to one embodiment, only the particular other member listed as a caregiver has access to edit or modify his/her caregiver schedule. As an example, edit icon 727 can be presented on the user's version of the user interface 700 next to the schedule for that specific user only. Accordingly, disclosed embodiments can simplify caregiver scheduling when multiple people from a group are providing care for another individual from within the group.

One or more embodiments can include: issuing a caretaker request to a corresponding communication device associated with each of the other associated individuals; and in response to receiving one or more caretaker responses, where each caretaker response identifies a registering user and one or more available time slots: creating a caretaker schedule based on the one or more caretaker responses; and for each other individual within the associated individuals, communicating the caretaker schedule to a corresponding communication device associated with the other individual.

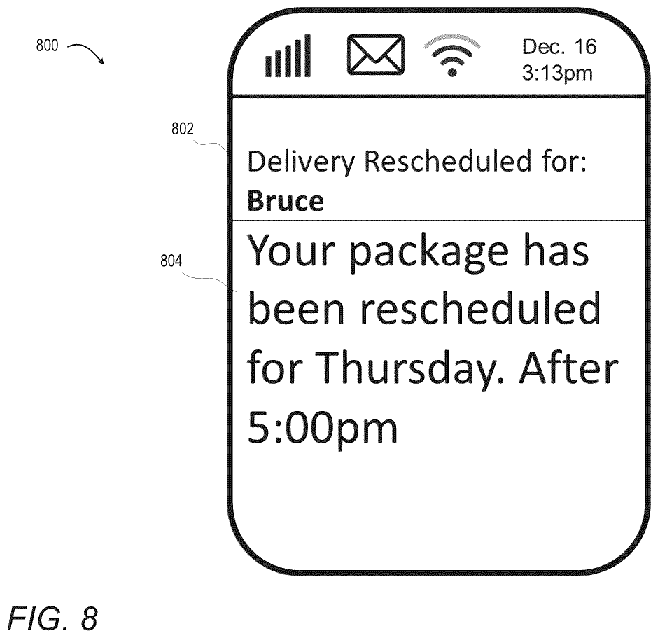

FIG. 8 illustrates an exemplary user interface 800 depicting notification of a rescheduled delivery, according to one or more embodiments. In one or more embodiments, the user interface shown in FIG. 8 may be rendered on a display 802 of a device such as device 100 of FIG. 1. User interface 800 can include a text field 804 to present a notification of a rescheduled delivery based on the activation of the GBDnD mode for an ailing individual that is a member of the HMCC group.

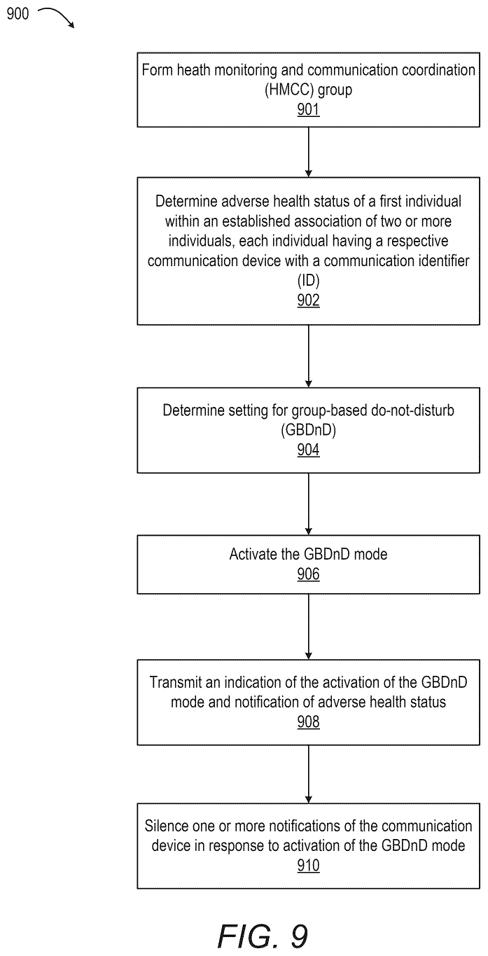

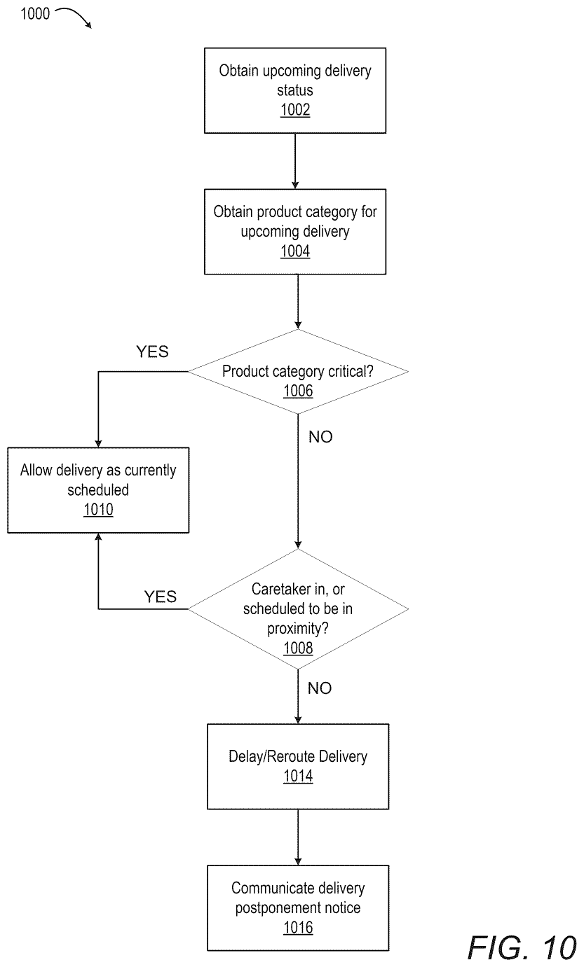

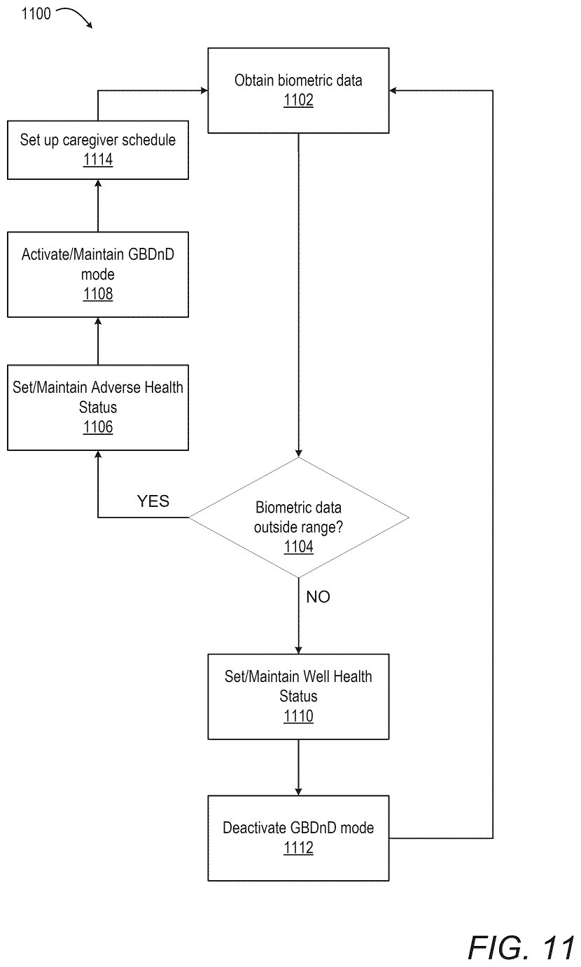

Referring now to the flowcharts presented by FIG. 9, FIG. 10, and FIG. 11, the descriptions of the methods in FIG. 9, FIG. 10, and FIG. 11 are provided with general reference to the specific components and features illustrated within the preceding FIGS. 1-8. Specific components referenced in the methods of FIG. 9, FIG. 10, and FIG. 11 may be identical or similar to components of the same name used in describing preceding FIGS. 1-8. In one or more embodiments, processor 102 (FIG. 1) configures electronic device 100 (FIG. 1) to provide the described functionality of the methods of FIG. 9, FIG. 10, and FIG. 11 by executing program code for one or more modules or applications provided within system memory 120 of electronic device 100, including GBDnD module 152 (FIG. 1).

FIG. 9 depicts a flowchart of a method 900 for activating group-based do-not-disturb (GBDnD) mode, according to one or more embodiments. The method 900 starts at block 901, where a health monitoring and communication coordination (HMCC) group is formed, such as depicted in FIG. 2. The method 900 continues to block 902, where an adverse health status of a first individual within an established association of two or more individuals is determined, in which each individual has a respective communication device with a communication identifier (ID). The communication identifier can include a telephone number, email address, username, and/or other suitable identifier. The method 900 continues to block 904, where a setting is determined for group-based do-not-disturb (GBDnD). The setting can include one or more configuration options, including but not limited to, a duration that the GBDnD mode is to be in effect, the type(s) of notification(s) that may be deferred or silenced during the GBDnD mode, and/or delivery rescheduling and/or rerouting options. The method continues to block 906 where the GBDnD mode is activated. The activating can include activating a do-not-disturb mode on the communication device associated with the individual that has indicated an adverse health condition. The method 900 continues to block 908, where an indication of the activation of the GBDnD mode and notification of adverse health status is transmitted to the other communication devices that are associated with members of the group. In this way, other group members are notified of the adverse health status of the individual, and can take appropriate steps, such as contributing to and/or viewing the caregiver schedule, reducing the frequency of their messages to the individual with the adverse health status, and so on. The method 900 continues to block 910, where, based on the activation of the GBDnD mode, one or more notifications of the communication device associated with the individual with the adverse health status are silenced. Accordingly, the method includes in response to receiving a notification and/or message while in the GBDnD mode, performing one or more of (i) withholding presentation of the notification, (ii) presenting the notification in silence, without audio, luminance of the device screen, or vibration of the device, and/or delaying presentation of the notification.

FIG. 10 depicts a flowchart of a method 1000 for delivery management when GBDnD mode is in effect, according to one or more embodiments. The method 1000 starts at block 1002, where an upcoming delivery status is obtained. In one or more embodiments, the upcoming delivery status can be obtained by automatically accessing an online account to retrieve order metadata. In one or more embodiments, the automatic accessing includes utilizing RESTful APIs, XML (extensible markup language), HTTP, JSON (JavaScript Object Notation), and/or other suitable techniques. In one or more embodiments, the upcoming delivery status can be obtained by automatically scanning received emails and/or messages from a merchant, and/or a delivery service (e.g., a postal service, and/or a commercial delivery service such as UPS, FedEx, and the like). The status can include metadata. The metadata can include an estimated delivery date, a delivery method (e.g., leave at the door, signature required, etc.), a product category, a product quantity, a product description, and/or other corresponding metadata. The method 1000 then continues to block 1004, where the product category is obtained from the metadata. The method 1000 then continues to block 1006 where a check is made to determine if the product category is critical. A critical category for a product indicates that the product should be delivered as planned, regardless of the GBDnD mode being active or not. Examples of critical categories can include, but are not limited to, food, medicine, and health care products. In one or more embodiments, a predetermined critical product category list is maintained on the communication device and/or on a server (e.g., such as server 175 of FIG. 1). In one or more embodiments, the critical category list can include categories such as food and medicine. In one or more embodiments, one or more members of the group may edit the critical category list to add and/or remove product categories. If at block 1006, it is determined that the product for an upcoming delivery is critical (based on the product category for at least one product in the delivery being on the critical product list), then the method 1000 continues to block 1010, where the delivery is allowed as currently scheduled.

One or more embodiments can include: obtaining a product category for the scheduled delivery; comparing the product category against a critical product category list; in response to the minimum distance of the nearest caregiver exceeding a predetermined threshold and the product category not being included in the critical product category list, issuing a delivery postponement notice for the scheduled delivery to the delivery service account device; and in response to the minimum distance of the nearest caregiver not exceeding the predetermined threshold or the product category being included in the critical product category list, communicating an alert to another individual to inform the other individual of the scheduled delivery while the first individual has the GBDnD mode set on the communication device.

If at block 1006, it is determined that the product for an upcoming delivery is not critical (based on the product category for each product in the delivery not being on the critical product list), then the method continues to block 1008, where a determination is made whether a caretaker is in proximity to the delivery location or expected to be at the delivery location at/or around the time of the delivery. In one or more embodiments, the determination can include parsing a caretaker schedule, such as depicted at 706 in FIG. 7. In one or more embodiments, the determination can include utilizing location services identifying the device location relative to the delivery location. The location services can include data from a geolocation receiver (e.g., 160 of FIG. 1) and/or other sources of positioning information such as WiFi, Bluetooth, and/or other wireless transmission standards. In one or more embodiments, a minimum distance threshold is established, such as 1 kilometer. In one or more embodiments, if at least one caretaker is within the minimum distance from the location, or will be within the minimum distance at the time of the scheduled delivery, then the method 1000 continues to block 1010 as previously described. In one or more embodiments, if a caretaker is scheduled to be in proximity to the individual with the adverse health status at the estimated delivery time, then the method continues to block 1010, where the delivery is allowed as currently scheduled. If instead, at block 1008, it is determined that a caretaker is not in proximity, then the method 1000 continues to block 1014, where the delivery is delayed and/or rerouted. In one or more embodiments, the rerouting of the delivery includes delivering the package to the address of another member of the group. In one or more embodiments, if no caretaker is within the minimum distance, then the method 1000 continues to block 1014 as previously described. In one or more embodiments, the delaying and/or rerouting of the delivery includes accessing an online system for a merchant and/or delivery service utilizing RESTful APIs, XML (extensible markup language), HTTP, JSON (JavaScript Object Notation), and/or other suitable techniques. The method 1000 then continues to block 1016, where a delivery postponement notice is silently communicated to the user.

One or more embodiments can include: in response to determining the adverse health status of the individual, for each other individual of the established association: determining a proximity between the communication device and a corresponding communication device associated with each other individual within the established association; determining, based on comparing each proximity, which other individual within the established association is a minimum distance away; obtaining, from a delivery service account device, an upcoming delivery status for a scheduled delivery; and in response to the minimum distance exceeding a predetermined minimum distance threshold, generating a delivery postponement notice for the scheduled delivery and communicating the delivery postponement notice to the delivery service account device. In cases where the caregiver is within the predetermined minimum distance, the scheduled delivery may be unaltered, since a caregiver is expected to be at the location of the ailing individual when the delivery is expected to arrive.

FIG. 11 depicts a flowchart of a method 1100 for setting a health status and activating a GBDnD mode based on biometric data, according to one or more embodiments. The method 1100 starts at block 1102, where biometric data is obtained. The biometric data can include, but is not limited to, temperature data, heart rate data, blood pressure data, blood sugar data, and so on. In one or more embodiments, biometric data may be obtained from a wearable electronic device such as a smartwatch that includes biometric sensors such as a heart rate monitor, pulse oximeter, and the like. The method 1100 continues to block 1104, where a check is made to determine if the biometric data is outside a predetermined range for the specific data being compared. As an example, one or more embodiments may establish a temperature range of 36 degrees Celsius to 37.5 degrees Celsius as a normal human body temperature range. In embodiments, obtained biometric data indicating a temperature outside of that range can cause an adverse health status to be set. Also, if the current health status of the individual is already set to an adverse health status, obtained biometric data indicating a temperature outside of that range could be used to maintain the setting of the adverse health status. If, at block 1104, it is determined that the biometric data is outside of the specified range, then the method 1100 continues to block 1106, where an adverse health status is set or maintained. In one or more embodiments, an option may be provided for a user to override the adverse health status. That is, if the biometric data is outside of the predetermined range, but the user is not ailing, then the user may override the adverse health status, and continue indicating a health status of ‘healthy.’ The method 1100 then continues to block 1108, where the GBDnD mode is activated for the device corresponding to the individual with the adverse health status. The method 1100 can include setting up a caregiver schedule at block 1114. In one or more embodiments, the caregiver schedule can be automatically initiated in response to activating a GBDnD mode for a member of the HMCC group. In one or more embodiments, a user interface such as 600 shown in FIG. 6 may be presented on electronic devices associated with members of the HMCC group, to solicit caregiver shift entries from group members, for creating an aggregated caregiver schedule. The method 1100 then returns to block 1102 to periodically obtain subsequent biometric data and continue monitoring the biometric data for any changes. If, at block 1104, it is determined that the biometric data is not outside of the specified range, then the method 1100 continues to block 1110, where a well (healthy) health status is set or maintained. The method 1100 then continues to block 1112, where the GBDnD mode is deactivated for the device corresponding to the individual with the adverse health status. The method 1100 then returns to block 1102 to periodically obtain subsequent biometric data and continue monitoring the biometric data for any changes. In one or more embodiments, a change in GBDnD mode results in a notification being sent to one or more electronic device associated with other members of the group. One or more embodiments can include: obtaining subsequent biometric data from one or more biometric data collection devices; determining if a value of the subsequent biometric data is outside of a predetermined range; and in response to determining that the value of the subsequent biometric data is within the predetermined range, setting the health status of the individual to a healthy status and disabling the GBDnD mode.

As can now be appreciated, disclosed embodiments provide techniques that help shield a sick, injured, and/or recovering person from undue interruptions and disturbances from deliveries, as well as excessive contact from other family members and friends. Additionally, disclosed embodiments further provide a feature of creating and disseminating a caregiver schedule in which one or more members of a group take turns caring for an ailing individual within the group. Furthermore, disclosed embodiments further reduce disturbances by automatically rescheduling deliveries for the ailing individual, under certain conditions. Thus, disclosed embodiments improve the technical field of group-based communication, and reduce disturbances for an ailing person, enabling the person to potentially recover more quickly.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. A communication device comprising:
at least one output device, including a display;
a communication system;
a memory having stored thereon a group-based do-not-disturb (GBDnD) module; and
at least one processor communicatively coupled to the display, the communication system, and the memory, the at least one processor executing program code of the GBDnD module and configuring the communication device to:
determine an adverse health status of a first individual within an established association of two or more individuals, each having a communication identifier (ID) and identified as included within the established association;
determine, in part based on the adverse health status of the first individual, a setting for a group-based do-not-disturb (GBDnD) mode to activate on the communication device;
activating the GBDnD mode based on the setting; and
in response to activating the GBDnD mode:
transmit, via the communication system, to one or more second communication devices of each other individual within the established association, an indication of the activation of the GBDnD mode on the communication device and notification of the adverse health status; and
silence one or more notifications of the communication device in response to activation of the GBDnD mode.

2. The communication device of claim 1, wherein to determine the adverse health status of the first individual, the at least one processor:
obtains biometric data from one or more biometric data collection devices;
determines if the biometric data has a value outside of a predetermined range that is indicative of an adverse health status; and
in response to determining that the biometric data has a value outside of the predetermined range, sets the health status of the first individual to the adverse health status.

3. The communication device of claim 1, wherein to determine the adverse health status of the first individual, the at least one processor:
obtains a health status indication of the first individual from a corresponding communication device associated with another individual within the established association; and
in response to obtaining a health status indication indicative of an adverse health status, sets the health status of the first individual to the adverse health status.

4. The communication device of claim 1, wherein further the at least one processor:
in response to determining the adverse health status of the first individual, for each other individual of the established association:
determines a proximity between the communication device and a corresponding communication device associated with each other individual within the established association;
determines, based on comparing each proximity, which other individual within the established association is a minimum distance away;
obtains, from a delivery service account device, an upcoming delivery status for a scheduled delivery; and
in response to the minimum distance exceeding a predetermined minimum distance threshold, generates a delivery postponement notice for the scheduled delivery and communicating the delivery postponement notice to the delivery service account device.

5. The communication device of claim 4, wherein further the at least one processor:
obtains a product category for the scheduled delivery;
compares the product category against a critical product category list;
in response to the minimum distance away exceeding a predetermined threshold and the product category not being included in the critical product category list, issues a delivery postponement notice for the scheduled delivery to the delivery service account device; and
in response to the minimum distance away not exceeding the predetermined threshold or the product category being included in the critical product category list, communicates an alert to the other individual to inform the other individual of the scheduled delivery while the first individual has the GBDnD mode set on the communication device.

6. The communication device of claim 2, wherein further the at least one processor:
obtains subsequent biometric data from one or more biometric data collection devices;
determines if a value of the subsequent biometric data is outside of a predetermined range; and
in response to determining that the value of the subsequent biometric data is within the predetermined range, sets the health status of the individual to a healthy status and disables the GBDnD mode.

7. The communication device of claim 1, wherein further the at least one processor:
in response to determining the adverse health status of the first individual:
issues a caretaker request to a corresponding communication device associated with each of the other associated individuals; and
in response to receiving one or more caretaker responses, wherein each caretaker response identifies a contact and one or more available time slots:
creates a caretaker schedule based on the one or more caretaker responses; and
for each other individual within the associated individuals, communicates the caretaker schedule to a corresponding communication device associated with the other individual.

8. The communication device of claim 1, wherein further the at least one processor:
in response to determining the adverse health status of the individual, for each contact of a group of contacts, provides an adverse status indication for the individual to a corresponding communication device associated with the contact.

9. The communication device of claim 1, wherein further the at least one processor:
in response to receiving an incoming adverse health status associated with another individual within the associated individuals:
marks a contact of the other individual with a GBDnD tag; and
surfaces the GBDnD tag to alert the first individual of the GBDnD in response to detecting selection of the contact for communicating with the first individual.

10. A method comprising:
determining, by a processor of a communication device, an adverse health status of a first individual within an established association of two or more individuals, each individual having a respective communication device with a communication identifier (ID) and identified as included within the established association;
determining, in part based on the adverse health status of the first individual, a setting for a group-based do-not-disturb (GBDnD) mode to activate on the communication device;
activating the GBDnD mode based on the setting; and
in response to activating the GBDnD mode:
transmitting, to one or more second communication devices of each other individual within the established association, an indication of the activation of the GBDnD mode on the communication device and notification of the adverse health status; and
silencing one or more notifications of the communication device in response to activation of the GBDnD mode.

11. The method of claim 10, further comprising:
obtaining biometric data from one or more biometric data collection devices;
determining if the biometric data has a value outside of a predetermined range that is indicative of an adverse health status; and
in response to determining that the biometric data has a value outside of the predetermined range, setting the health status of the individual to the adverse health status.

12. The method of claim 11, further comprising:
obtaining a health status indication of the first individual from a corresponding communication device associated with another individual within the established association; and
in response to obtaining a health status indication indicative of an adverse health status, setting the health status of the first individual to the adverse health status.

13. The method of claim 10, further comprising:
in response to determining the adverse health status of the individual, for each other individual of the established association:
determining a proximity between the communication device and a corresponding communication device associated with each other individual within the established association;
determining, based on comparing each proximity, which other individual within the established association is a minimum distance away;
obtaining, from a delivery service account device, an upcoming delivery status for a scheduled delivery; and
in response to the minimum distance away exceeding a predetermined minimum distance threshold, generating a delivery postponement notice for the scheduled delivery and communicating the delivery postponement notice to the delivery service account device.

14. The method of claim 13, further comprising:
obtaining a product category for the scheduled delivery;
comparing the product category against a critical product category list;
in response to the minimum distance away exceeding a predetermined threshold and the product category not being included in the critical product category list, issuing a delivery postponement notice for the scheduled delivery to the delivery service account device; and
in response to the minimum distance away not exceeding the predetermined threshold or the product category being included in the critical product category list, communicating an alert to the other individual to inform the other individual of the scheduled delivery while the first individual has the GBDnD mode set on the communication device.

15. The method of claim 11, further comprising:
obtaining subsequent biometric data from one or more biometric data collection devices;
determining if a value of the subsequent biometric data is outside of a predetermined range; and
in response to determining that the value of the subsequent biometric data is within the predetermined range, setting the health status of the individual to a healthy status and disabling the GBDnD mode.

16. The method of claim 10, further comprising:
issuing a caretaker request to a corresponding communication device associated with each of the other associated individuals; and
in response to receiving one or more caretaker responses, wherein each caretaker response identifies a contact and one or more available time slots:
creating a caretaker schedule based on the one or more caretaker responses; and
for each other individual within the associated individuals, communicating the caretaker schedule to a corresponding communication device associated with the other individual.

17. The method of claim 10, further comprising, in response to determining the adverse health status of the individual, for each contact of a group of contacts, providing an adverse status indication for the individual to a corresponding communication device associated with the contact.

18. The method of claim 10, further comprising:
in response to receiving an incoming adverse health status associated with another individual within the associated individuals:
marking a contact of the other individual with a GBDnD tag; and
surfacing the GBDnD tag to alert the first individual of the GBDnD in response to detecting selection of the contact for communicating with the first individual.

19. A computer program product comprising a non-transitory computer readable medium having program instructions that when executed by a processor of a communication device comprising a display, configure the communication device to perform functions comprising:
determining an adverse health status of a first individual within an established association of two or more individuals, each having a communication identifier (ID) and identified as included within the established association;
determining, in part based on the adverse health status of the first individual, a setting for a group-based do-not-disturb (GBDnD) mode to activate on the communication device;
activating the GBDnD mode based on the setting; and
in response to activating the GBDnD mode:
transmitting, to one or more second communication devices of each other individual within the established association, an indication of the activation of the GBDnD mode on the communication device and notification of the adverse health status; and
silencing one or more notifications of the communication device in response to activation of the GBDnD mode.

20. The computer program product of claim 19, further comprising program instructions for: in response to determining the adverse health status of the first individual, for each other individual of the established association and in response to obtaining, from a delivery service account device, an upcoming delivery status for a scheduled delivery:
determining a proximity between the communication device and a corresponding communication device associated with each other individual within the established association; and
determining, based on comparing each proximity, which other individual within the established association is a minimum distance away; and
in response to the minimum distance away exceeding a predetermined minimum distance threshold, generating a delivery postponement notice for the scheduled delivery and communicating the delivery postponement notice to the delivery service account device.
